(19) United States
(12) Patent Application Publication
(10) Pub. No.: US 2004/0194898 A1
(43) Pub. Date: Oct. 7, 2004

(54) Venetian blind having lift cord stopper

(75) Inventor: Ming Nien, Changhua Hsien (TW)

Correspondence Address: BROWDY AND NEIMARK, P.L.L.C., 624 NINTH STREET, NW, SUITE 300, WASHINGTON, DC, 20001-5303, US

(73) Assignee: NIEN MADE ENTERPRISE CO., LTD., Taichung, Taiwan

(21) Appl. No.: 10/612,044

(22) Filed: Jul. 3, 2003

(30) Foreign Application Priority Data
Apr. 3, 2003 (TW) 92205221

(51) Int. Cl. E06B 9/30

(52) U.S. Cl. 160/168.1 R

(57) ABSTRACT

A safety window blind assembly formed of a headrail, a bottom rail, a plurality of slats, a blind supporting system, two lift cords, and a lift lock is disclosed to further include two cord stoppers respectively coupled to the lift cords and adapted to limit the moving distance of the lift cords relative to the lift lock and to further prevent a sudden dropping of the bottom rail upon failure of the lift lock. Each cord stopper has a center wire hole adapted to receive a part of one lift cord and two retaining grooves formed in the periphery thereof for retaining the part of the lift cord been inserted through the center wire hole.

### BACKGROUND OF THE INVENTION

1. Field of the Invention

The present invention relates generally to window blind assemblies and, more particularly, to a safety window blind assembly that has lift cord stopper means.

2. Description of the Related Art

Venetian blinds are intensively used in building construction to regulate light passing through windows and to decorate windows. FIG. 1 illustrates a window blind assembly constructed according to U.S. Pat. No. 6,453,974. According to this design, the window blind assembly comprises a top traverse supporter 11, a bottom bar 12, a plurality of slats 14, a blind supporting system 13 for suspendedly and spacedly supporting the slats 14 horizontally between the top traverse supporter 11 and the bottom bar 12, and a lifting operation system for selectively lifting up the bottom bar 12 towards the top traverse supporter 11 and unlifting the bottom bar 12 to drop downwardly away from the top traverse supporter 11, wherein the lifting operation system comprises a lift lock 16 rotatably mounted on the top traverse supporter 11 and a pair of lift cords 15 each having a first end portion affixed to the bottom bar 12, wherein the two lift cords 15 upwardly extend and penetrate through the slats 14 parallelly and then traversely extend through the top traverse supporter 11 while a second end portion 151 of each of the lift cords 15 is extended out of the top traverse supporter 11 via the lift lock 16 to control the folding and unfolding of the window blind assembly. However, the slats 14 may accidentally slide down while the cords 15 are pulled unintentionally, especially when a child plays with the blind or pulls the middle portion 152 of each lift cord 15, the bottom bar 12 of the window blind assembly may accidentally drop down, which will cause unwanted injury to the soft and weak child. Due to the safety purpose, the blind must incorporate with a safety device that can stop the slats from being dropped down accidentally. According to U.S. Pat. No. 6,453,974, two cord stoppers 17 are respectively slidably connected on the second end portions 151 of the lift cords 15. The cord stoppers 17 can lock the slats 14 of the window blind assembly in position, so as to prevent the slats 14 from being slid down accidentally. According to this design, the cord stoppers 17 each include a locking guider slidably connected on the second end portion 151 of one lift cord 15 of the window blind assembly by constructing an adjustable knot at a guiding through slot of the locking guider. According to this design, it is complicated and inconvenient to construct an adjustable knot at the guiding through slot of the locking guider of each cord stopper 17.

Therefore, it is desirable to provide a window blind assembly that eliminates the aforesaid drawbacks.

### SUMMARY OF THE INVENTION

The present invention has been accomplished to provide a safety blind, which eliminates the aforesaid drawbacks. It is therefore the main object of the present invention to provide a safety window blind assembly, which prevents excessively stretching of the lifting portion of each lift cord being inserted through the slats.

It is another object of the present invention to provide a safety window blind assembly, which has means top stop the bottom rail from falling when the lift lock failed.

It is still another object of the present invention to provide a safety window blind assembly, which is easy assemble.

To achieve these objects of the present invention, the window blind assembly comprises a headrail; a bottom rail; a plurality of slats; a blind supporting system suspendedly and spacedly supporting the slats horizontally between the headrail and the bottom rail; at least one lift cord having a first end fixedly fastened to the bottom rail and a second end extending upwardly through the slats into the headrail and then downwardly through a lift lock in a bottom side of the headrail and terminating in an operation portion suspended below the headrail at a distance; and at least one cord stopper coupled to the lift cord. The cord stopper has a center wire hole adapted to receive a part of the lift cord and two retaining grooves formed in the periphery thereof and spaced from the center of the cord stopper at different sides for retaining the part of the lift cord been inserted through the center wire hole.

### BRIEF DESCRIPTION OF THE DRAWINGS

FIG. 1 is a perspective view of a window blind assembly according to U.S. Pat. No. 6,453,974.

FIG. 2 is a perspective view of a safety window blind assembly according to the present invention.

FIG. 3 is a perspective view of a cord stopper for use in the safety window blind assembly according to the present invention.

FIG. 4 is an enlarged view of a part of FIG. 2 showing the cord stopper fastened to the lift cord.

FIGS. 5 and 6 are schematic drawings showing how the cord stopper fastens to the lift cord according to the present invention.

FIG. 7 is another perspective view of the present invention, showing one cord stopper stopped at the bottom rail outside the lift lock.

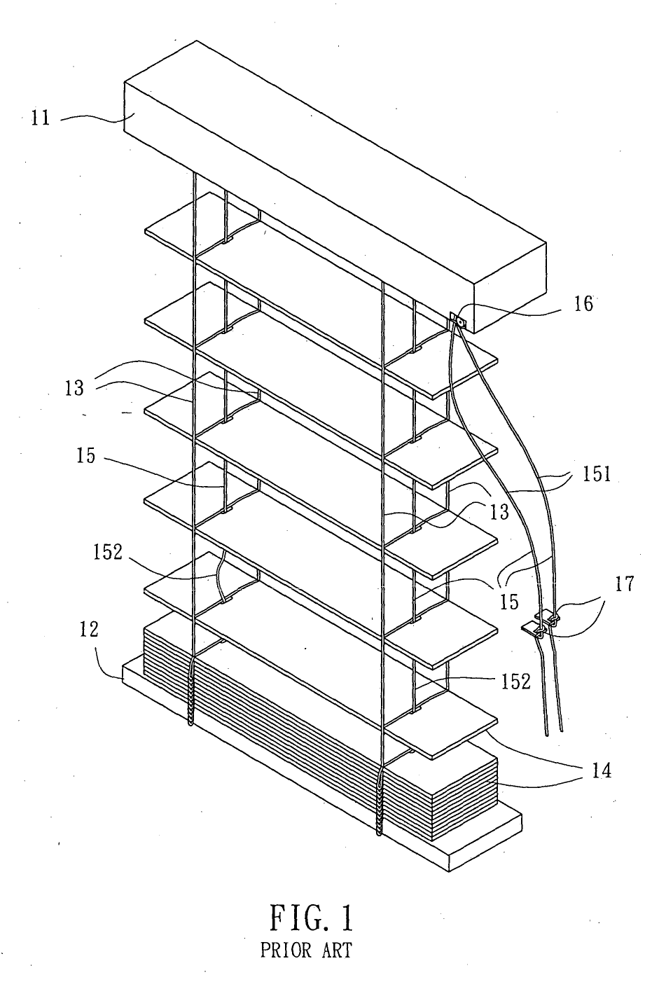

### DETAILED DESCRIPTION OF THE INVENTION

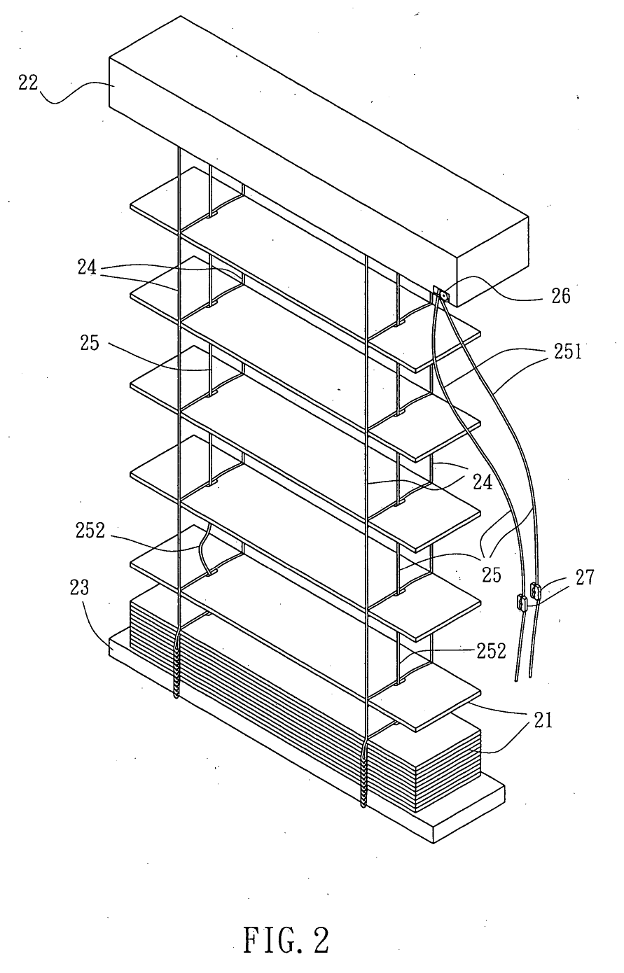

Referring to Referring to FIG. 2, a safety window blind assembly in accordance with the present invention is shown, similar to a conventional window blind assembly, comprising a headrail 22, a bottom rail 23, a plurality of slats 21 arranged in parallel between the headrail 22 and the bottom rail 23, a blind supporting system, i.e., symmetrical pairs of ladder tapes 24 for suspendedly and spacedly supporting the slats 21 horizontally between the headrail 22 and the bottom rail 23, two lift cords 25 for controlling the elevation of the bottom rail 23, and a lift lock 26 mounted in the headrail 22 near one end and adapted to lock the lift cords 25. The lift cords 25 each has one end fixedly fastened to the bottom rail 23, and the other end extending upwardly through the slats 21 into the inside of the headrail 22 and then rightwards toward the right end of the headrail 22 and then downwardly through the lift lock 26 to the outside of the headrail 22. The user adjustably divides each lift cord 25 into a lifting portion 252 that passes through the slats 21 and the headrail 22, and an operation portion 251 that extends out of the headrail 22 for pulling. The safety window blind assembly further comprises two cord stoppers 27 respectively coupled to the operation portions 251 of the lift cords 25.

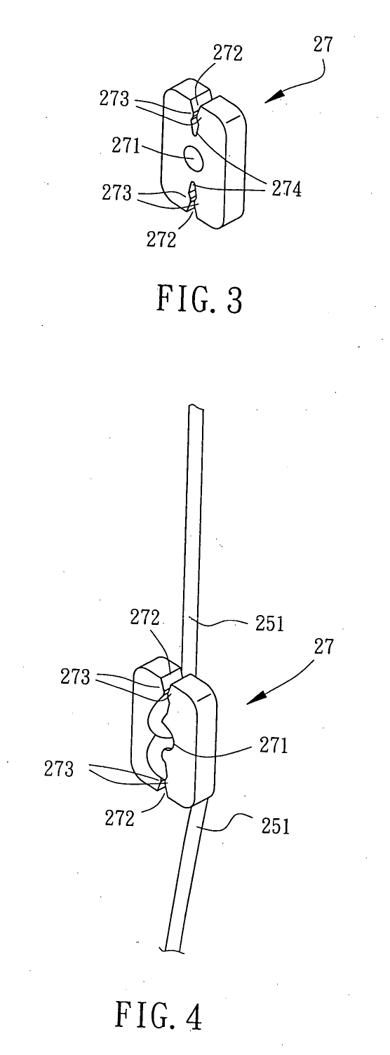

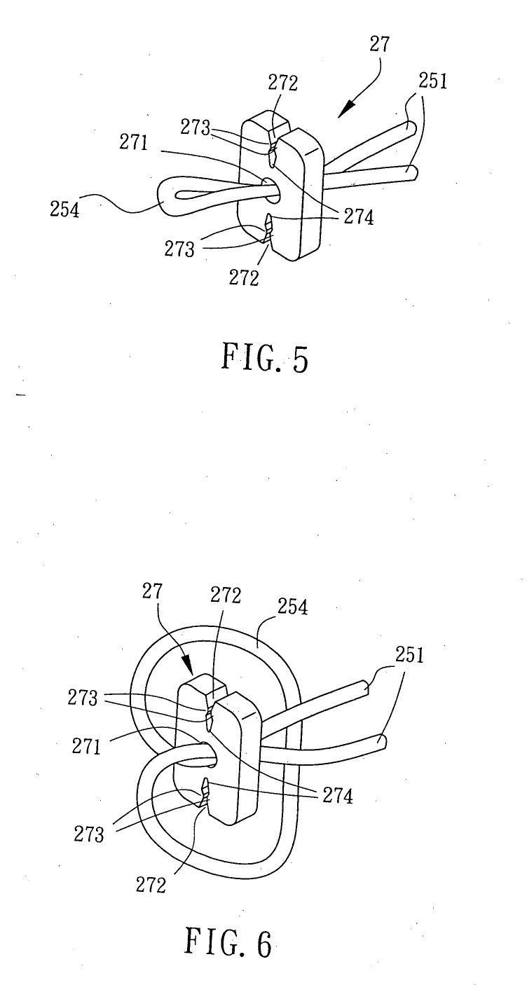

Referring to FIG. 3, the cord stoppers 27 are flat block members, each having a center wire hole 271 and two retaining grooves 272. The center wire hole 271 is a through hole through the front and back sides of the respective cord stopper 27 at the center. The two retaining grooves 272 are symmetrically in the periphery of the respective cord stopper 27 and equally spaced from the center (the center wire hole 271) of the respective cord stopper 27 at two sides. Each retaining groove 272 has a width gradually reduced from the periphery toward the center of the respective cord stopper 27. Each cord stopper 27 further comprises two pairs of protruded stop portions 273 respectively suspended in the retaining grooves 272 at two sides and facing each other. Each pair of protruded stop portions 273 define with the inner end of the corresponding retaining groove 272 an engagement space 274.

Referring to FIGS. 4˜6, the operation portion 251 is folded up and inserted through the center wire hole 271 of the cord stopper 27, and then the open loop 254 thus formed of the folded operation portion 251 is turned backwards and hung in the retaining grooves 272, for enabling the open loop 254 of the folded operation portion 251 to be forced through the protruded stop portions 273 into the respective engagement spaces 274, and then the operation portion 251 is pulled tightly. Because the retaining grooves 272 have a width gradually reduced from the periphery toward the center of the cord stopper 27, the operation portion 251 can easily be forced into the retaining grooves 272 and set into engagement with the engagement spaces 274. When set into the engagement spaces 274, the protruded stop portions 273 stop the operation portion 251 from escaping out of the engagement spaces 274. When in use, the cord stoppers 27 are kept away from the lift lock 26 at a predetermined distance.

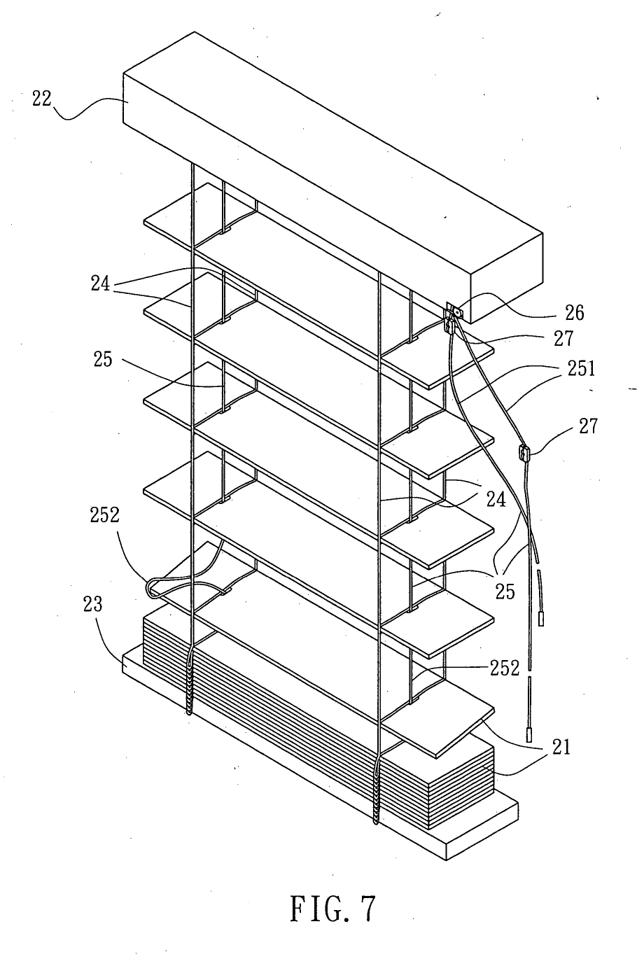

Referring to FIG. 7, normally, the lift lock 26 controls the sliding status of the lift cords 25. When the lift lock 26 failed, the slats 21 and the bottom rail 23 drop due to the effect of their gravity weight, thereby causing the operation portion 251 of each lift cord 25 to move relative to the lift lock 26 toward the inside of the headrail 22. When the operation portion 251 of each lift cord 25 moving toward the inside of the headrail 22, the respective cord stopper 27 will be stopped at the lift lock 26 to limit the downward movement of the bottom rail 23 and the slats 21 within a predetermined safety range, preventing the falling bottom rail 23 from hitting a person.

Referring to FIG. 7 again, when a child pulling the lifting portion 252 of one lift cord 25 for fun, the cord stopper 27 of the corresponding lift cord 25 will be stopped at the lift lock 26 to limit the stretching of the lift cord 25.

As indicated above, the safety window blind assembly of the present invention achieves advantages as follows:

1. The cord stopper 27 in each lift cord 25 limits the sliding distance of the respective lift cord 25 relative to the lift lock 26, preventing a sudden falling of the bottom rail 23 upon failure of the lift lock 26.

2. By means of inserting the middle part of the operation portion 251 of the lift cord 25 into the center wire hole 271, the respective cord stopper 27 is easily installed in the respective lift cord 25.

3. The vertical moving distance of the bottom rail 23 and the stretching distance of the lifting portion 252 of the respective lift cord 25 can be controlled by adjusting the position of the cord stopper 27 in the respective lift cord 25.

4. The design of the engagement spaces 274 in the retaining grooves 272 enables the respective cord stopper 27 to be positively secured to the respective lift cord 25.

5. By means of loosening the open loop 254 of the lift cord 25, the respective cord stopper 27 is unlocked and allowed to be moved relative to the respective lift cord 25 to the desired elevation.

6. The invention can be employed to conventional window blind assemblies without changing the original structural design.

7. The installation of the cord stoppers 27 does not affect the sense of beauty of the window blind assembly.

Although a particular embodiment of the invention has been described in detail for purposes of illustration, various modifications and enhancements may be made without departing from the spirit and scope of the invention. For example, by means of expanding the diameter of the center wire hole 271 and/or increasing the number of the retaining grooves 272, the cord stopper 27 can be fastened to a plurality of lift cords 25. Further, the retaining grooves 272 can be formed in two adjacent peripheral sides of the cord stopper 27. Accordingly, the invention is not to be limited except as by the appended claims.

What is claimed is:

1. A window blind assembly comprising:
a headrail;
a bottom rail;
a plurality of slats;
a blind supporting system suspendedly and spacedly supporting said slats between said headrail and said bottom rail;
at least one lift cord having a first end fixedly fastened to said bottom rail and a second end extending upwardly through said slats into said headrail and then downwardly through a lift lock in a bottom side of said headrail and terminating in an operation portion suspended below said headrail at a distance; and
at least one cord stopper respectively coupled to said at least one lift cord, said cord stopper having a center wire hole for receiving a part of said lift cord and two retaining grooves formed in the periphery thereof and spaced from the center of the cord stopper at different sides for retaining the part of the lift cord been inserted through said center wire hole.

2. The safety window blind assembly as claimed in claim 1, wherein said retaining grooves are respectively formed in the periphery of the cord stopper and spaced from the center of the respective cord stopper at two opposite sides.

3. The safety window blind assembly as claimed in claim 1, wherein said cord stopper further comprises two pairs of protruded stop portions respectively suspended in the retaining grooves of the cord stopper at two sides and facing each other.

4. The safety window blind assembly as claimed in claim 1, wherein said retaining grooves each have a width made gradually reducing from the periphery of the cord stopper toward the center of the cord stopper.

5. The safety window blind assembly as claimed in claim 1, wherein the operation portion of said lift cord has a middle part folded up and inserted through the center wire hole of said cord stopper, forming an open loop, said open loop being turned backwards and hung in the retaining grooves of the cord stopper.

6. The safety window blind assembly as claimed in claim 3, wherein the operation portion of said lift cord has a middle part folded up and inserted through the center wire hole of said cord stopper, forming an open loop, said open loop being turned backwards and hung in the retaining grooves of the cord stopper and then forced through the protruded stop portions of the cord stopper and engaged into the engagement spaces of the cord stopper.
